(19) United States
(12) Patent Application Publication
(10) Pub. No.: US 2007/0282804 A1
(43) Pub. Date: Dec. 6, 2007

(54) Apparatus and method for extracting database information from a report

(75) Inventor: Mark Keith Bowman, Staines (GB)

Correspondence Address: COOLEY GODWARD KRONISH LLP;ATTN: Patent Group, Suite 1100, 777 - 6th Street, NW, Washington, DC, 20001, US

(73) Assignee: Business Objects, S.A., Levallois-Perret (FR)

(21) Appl. No.: 11/445,447

(22) Filed: May 31, 2006

(51) Int. Cl. G06F 17/30

(52) U.S. Cl. 707/3

(57) ABSTRACT

A computer implemented method includes extracting query information from a report, generating database information characterizing table and column metadata for a data source, and analyzing the relationships between the query information and the database information to identify a table and column invoked by the report.

### BRIEF DESCRIPTION OF THE INVENTION

The present invention relates generally to data processing. More particularly, the present invention relates to a technique for determining dependencies between data.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information, content delivery infrastructure systems for delivery and management of reports and analytics, data warehousing systems for cleansing and consolidating information from disparate sources, and data management systems, such as relational databases or On Line Analytic Processing (OLAP) systems used to collect, store, and manage raw data.

There are a number of commercially available products to produce reports from stored data. For instance, Business Objects Americas of San Jose, Calif., sells a number of widely used report generation products, including Crystal Reports™, Business Objects OLAP Intelligence™, Business Objects Web Intelligence™, and Business Objects Enterprise™. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike other non-report documents that may optionally import external data within a document, a report document by design is primarily a medium for accessing and formatting, transforming or presenting external data.

A report is specifically designed to facilitate working with external data sources. In addition to information regarding external data source connection drivers, the report may specify advanced filtering of data, information for combining data from different external data sources, information for updating join structures and relationships in report data, and logic to support a more complex internal data model (that may include additional constraints, dependencies, relationships, and metadata).

In contrast to a spreadsheet, a report is generally not limited to a table structure but can support a range of structures, such as sections, cross-tables, synchronized tables, sub-reports, hybrid charts, and the like. A report is designed primarily to support imported external data, whereas a spreadsheet equally facilitates manually entered data and imported data. In both cases, a spreadsheet applies a spatial logic that is based on the table cell layout within the spreadsheet in order to interpret data and perform calculations on the data. In contrast, a report is not limited to logic that is based on the display of the data, but rather can interpret the data and perform calculations based on the original (or a redefined) data structure and meaning of the imported data. The report may also interpret the data and perform calculations based on pre-existing relationships between elements of imported data. Spreadsheets generally work within a looping calculation model, whereas a report may support a range of calculation models. Although there may be an overlap in the function of a spreadsheet document and a report document, these documents express different assumptions concerning the existence of an external data source and different logical approaches to interpreting and manipulating imported data.

The present invention relates to the analytical and reporting aspects of BI. Analyzing information concerning the dependencies between a report document and the database that it relies is critical to risk management when modifying reports or databases. Identifying existing dependencies in a report document assists in avoiding any danger that may arise when altering the report document. While there are existing tools that allow reports to store information regarding their data source and the query statement used against the database, these tools do not enable a method to determine dependences between report data and the database that it relies on.

Therefore, it would be desirable to provide a new technique to select a report or plurality of reports and determine the database tables and columns that the reports are dependent on. In particular, reports are often based on semantic metadata layers or database views that may require additional resolution of aliases and additional dependencies in the case of views. Hence, it would be desirable to provide a method that processes the Structured Query Language (SQL) of a report to resolve any aliases and dependencies to produce a table that characterizes any dependencies between reports and the databases they rely upon.

### SUMMARY OF THE INVENTION

The invention includes a computer-readable medium to direct a computer to function in a specified manner. In particular, the computer-readable medium includes executable instructions to extract query information from a report, generate database information characterizing table and column metadata for a data source, and analyze the relationships between the query information and the database information to identify a table and column invoked by the report.

The invention also includes a computer implemented method of extracting query information from a report, generating database information characterizing table and column metadata for a data source, and analyzing the relationships between the query information and the database information to identify a table and column invoked by the report.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a computer that may be operated in accordance with an embodiment of the invention.

FIG. 2 illustrates processing operations performed in accordance with an embodiment of the invention.

FIG. 3 illustrates more detailed processing operations implemented with components utilized in accordance with an embodiment of the invention.

### DETAILED DESCRIPTION OF THE INVENTION

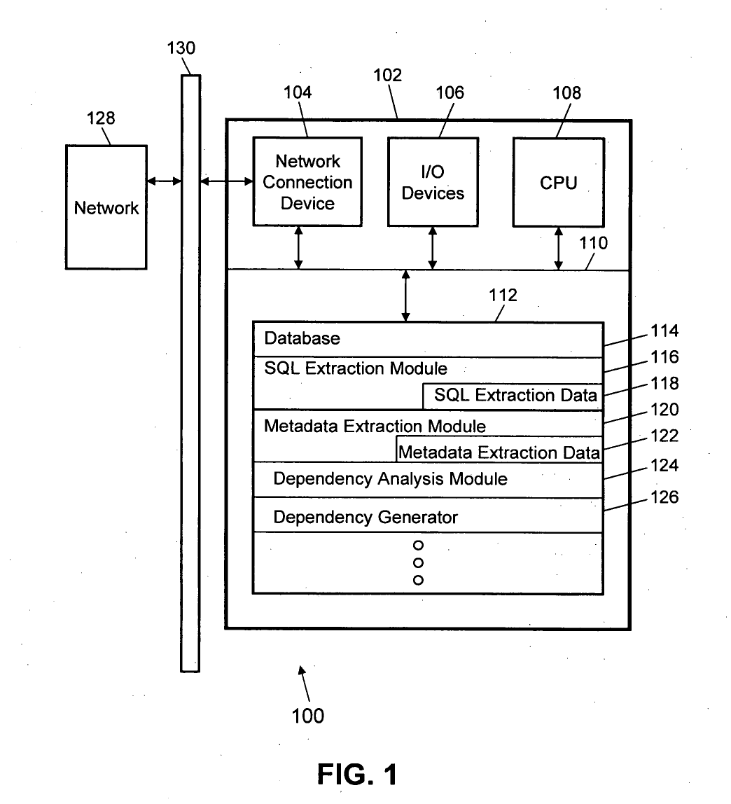

FIG. 1 illustrates a computer network 100 that may be operated in accordance with an embodiment of the invention. The computer network 100 includes a computer 102, which, in general, may be a client computer or a server computer. In the present embodiment of the invention, the computer 102 is a server computer including conventional server computer components. As shown in FIG. 1, the computer 102 includes a Central Processing Unit (“CPU”) 108 that is connected to a network connection device 104 and a set of input/output devices 106 (e.g., a keyboard, a mouse, a display, a printer, a speaker, and so forth) via a bus 110. The network connection device 104 is connected to network 128 through a network transport medium 130, which may be any wired or wireless transport medium.

The CPU 108 is also connected to a memory 112 via the bus 110. The memory 112 stores a set of executable programs. One executable program is the SQL extraction module 116. The SQL extraction module 116 includes executable instructions to access a report document from a data source and extract the SQL from the report. The SQL extraction module 116 outputs the results of the extraction as SQL extraction data 118. By way of example, the data source may be database 114 resident in memory 112. The data source may be located anywhere in the network 128.

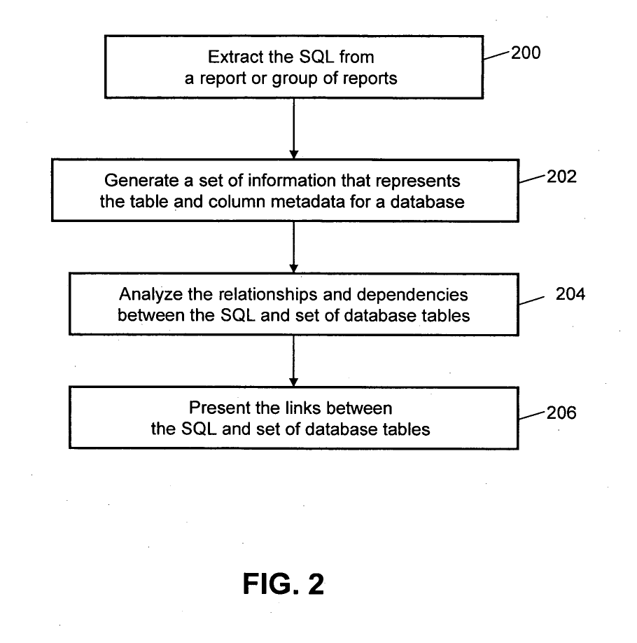

As shown in FIG. 1, the memory 112 also contains a metadata extraction module 120. The metadata extraction module 120 includes executable instructions to extract the basic table and column metadata from a data source then output the extraction as metadata extraction data 122. The data source may be a database or warehouse and may be located in the network 128. By way of example, the data source may be database 114 resident in memory 112. FIG. 1 also shows that memory 112 also contains a dependency analysis module 124. The dependency analysis module 124 determines any dependencies that exist between the reports and database or warehouse that it relies on. By way of example, the dependency analysis module 124 may include executable instructions to match the SQL extraction data 118 to the metadata extraction data 122 to identify any dependencies between the data. The dependency generator 126 may then produce information characterizing the dependencies identified by the dependency analysis module 124. In one embodiment of the invention, the dependency generator 126 produces a table characterizing the results of matching the SQL extraction data 118 to the metadata extraction data 122 according to the processing operations illustrated in FIG. 2.

While the various components of memory 112 are shown residing in the single computer 102, it should be recognized that such a configuration is not required in all applications. For instance, the dependency analysis module 124 may reside in a separate computer (not shown in FIG. 1) that is connected to the network 128. Similarly, separate modules of executable code are not required. The invention is directed toward the operations disclosed herein. There are any number of ways and locations to implement those operations, all of which should be considered within the scope of the invention.

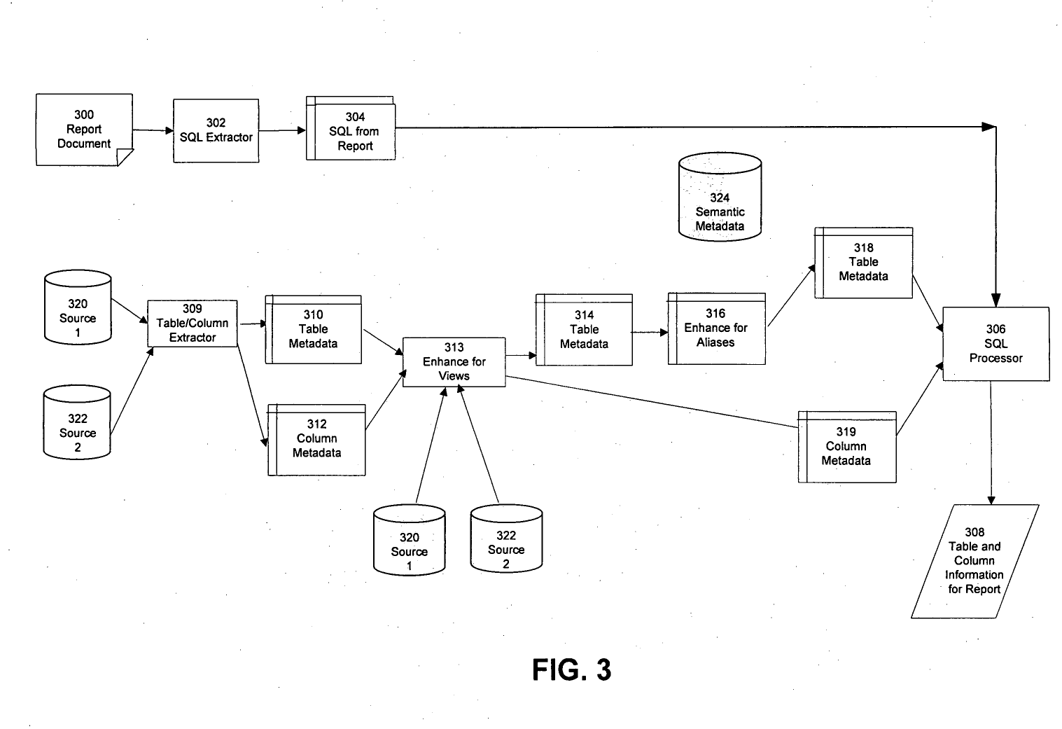

FIG. 2 illustrates processing operations associated with an embodiment of the invention. The first processing operation shown in FIG. 2 is to extract the SQL from a report or group of reports 200. In one embodiment of the invention, this is implemented with executable code of the SQL extraction module 116. Multiple report documents may be chosen programmatically or based on user input using various user interfaces. Reports may be selected based on what type of question is answered by the report, from a list or report names, or by the report's physical location. As shown in FIG. 3, SQL is extracted 302 from a selected report 300 and is stored as text string 304 for later processing by an SQL processor 306. In one embodiment of the invention, the SQL extraction module 116 may extract the SQL from the selected reports as a text string and store it as SQL extraction data 118.

The next processing operation shown in FIG. 2 is to generate information that represents the table and column metadata for a database 202 that the selected reports rely on. Reports often store information regarding their data source and the query statement used against the database or warehouse. Thus, the database that a report relies on may be identified using the report's metadata. The metadata extraction module 120 may then generate table and column metadata information from the source database through a three stage process as exemplified in FIG. 3. First, the table and column metadata is extracted 309 from the source databases or warehouses 320, 322. In this example, the table and column metadata is read from the source databases or warehouses 320 322 and written into two tables, table metadata 310 and column metadata 312. The table metadata 310 contains one row per table within the original data sources and the column metadata 312 contains one row for each column per table in the original data sources. The table metadata 310 and column metadata 312 may be stored as virtual tables.

Second, the tables are enhanced for views 313 against the original data sources 320, 322. This process provides a mapping between the column of a view and the data source that it uses. While enhancing for views, additional dependencies based on the view may need to be resolved. For instance, if a report was based on a view that was dependent on a table that was not reflected in the data of the report, the dependency would nevertheless need to be identified to ensure that the dependency information for the report reflected the tables and columns necessary to the view. In this example, the tables and columns are required by the report to query its data sources. Lastly, the table metadata 314 is enhanced for aliases 316 based on semantic data 324. A table or view added to the universe of data may be given a new name, or alias. This enhancing process resolves the mapping required to use any aliases based on universal semantic data. Ultimately, the process, after enhancing, generates two tables, the table metadata 318 and column metadata 319. In one embodiment of the invention, the metadata extraction module 120 stores these tables as metadata extraction data 122. Optionally, if there are multiple data sources, additional tables in the data sources may be added to the schema.

Returning to FIG. 2, the next processing operation is to analyze the relationships and dependencies between the SQL and set of database tables 204. The dependency analysis module 124 may match the SQL extraction data 118 and the metadata extraction data 122 to identify the dependencies or links between data. As shown in FIG. 3, the SQL from a report 304 is analyzed against the table metadata 318 and column metadata 319 by an SQL processor 306. If there are multiple warehouses, links between the report and additional data warehouses would also be identified. Before any analysis is executed, the table and column metadata tables are populated to ensure that any identified links or dependencies are accurate. In one embodiment of the invention, pre-processing of a report document is accomplished before any analysis to optimize efficiency when looking up a relationship.

The last processing operation shown in FIG. 2 is to present the links between the SQL and set of database tables 206. For example, the dependency generator 126 may use the analysis executed by the dependency analysis module 124 to produce a table that contains information regarding links between the report and the table and columns used by the report query. To illustrate, in FIG. 3 the SQL processor 306 matched the SQL from a report 304 and metadata tables 318, 319 to produce a table and column information for report 308 that characterizes the dependencies or links between the report and the tables and columns that the report relies upon.

The invention has now been fully disclosed. The following discussion provides details associated with an embodiment of the invention. The dependency analysis module 124 may provide an SQL join between the table that holds the report SQL and the table(s) that hold the Table and Column metadata. Assume the following simplified example:
A Table ReportSQL (Report_Id integer, Report_SQL char(1000)) holds the SQL statement for each report
A Table TableMetadata (Table_Id integer, Table_Name char(20),
Table_Alias_Name char(20)) holds 1 row for each table in a warehouse (e.g., a BusinessObjects Warehouse)
A Table ColumnMetadata (Column_Id integer, Table_Id integer, Column_Name char(20)) holds 1 row for each column in the BusinessObjects Warehouse, with a unique Column_Id for each column

Based upon the foregoing example, the SQL used by the dependency analysis module 124 may be:

### Select ReportSQL.Report_ID, ColumnMetadata.Column_Id

### From ReportSQL, TableMetadata, ColumnMetadata

### Where ColumnMetadata.Table_Id=TableMetadata.Table_Id

### And StringPos(ReportSQL.Report_SQL, TableMetadata.Table_Alias_Name+ColumnMetadata.Column_Name)=0

In this example StringPos(Source$, Target$) returns the position in Source$ of Target$, with a return value of 0 meaning Target$ is not in Source$. So when this returns any value other than 0, it means that Target$ is in Source$, or in this example that the Table.Column is in the Report SQL.

### So if

### ReportSQL holds [1, “select TableTwo.Col1 from Tab2 TableTwo”]

### TableMetadata holds [1, “Tab1”, “TableOne”] [2, “Tab2”, “TableTwo”] . . .

### ColumnMetadata holds [1,1, “Col1”] [2,1, “Col2”] [3,1, “Col3”] [4,2, “Col1”] [5,2, “Col2”] . . .

Then this SQL would return 1 row [1,4] meaning Report_Id (1) uses ColumnMetadata (4) which is Tab2.Col1 (aliased as TableTwo.Col1)

As previously indicated, the metadata extraction module produces metadata extraction data, which describes each table and column in the database. For example, the metadata extraction data may include tables TableMetadata and ColumnMetadata, providing a clean subset of all the SQL Server Metadata, i.e. only the subset required to implement operations of the invention.

For Tables and Views the metadata collected is the Name of the Table/View, and a flag to determine that this is either a Table or a View. For Columns (of either a Table or a view) this is [column name, column data type, column length]. Enhancing views entails mapping between the column of a view and the column(s) of the table(s) that the view.column uses. For example, in a Business Objects Universe, a ‘Table’ or ‘View’ added to the Universe from the database can be given a new name or an ‘Alias’. The ‘Table’/‘View’ can be added as many times as desired, provided each instance is given a unique Alias name.

For example, if a table called Tab2 is added to a Universe, it might be given the Alias name TableTwo. In the example above it is the Table_Alias_Name column of TableMetadata that is being populated from the Universe semantic data. It should be noted that not all tables in the Universe will be given an Alias, in this case the Table_Alias_Name in TableMetadata is populated with the same value held in Table_Name.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

While the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt to a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

What is claimed is:

1. A computer-readable medium to direct a computer to function in a specified manner, comprising executable instructions to:
extract query information from a report;
generate database information characterizing table and column metadata for a data source; and
analyze the relationships between the query information and the database information to identify a table and column invoked by the report.

2. The computer-readable medium of claim 1, wherein the executable instructions to extract include executable instructions to extract a Structured Query Language (SQL) statement from the report.

3. The computer-readable medium of claim 1, further comprising executable instructions to produce a table containing report dependencies on database tables and columns.

4. The computer-readable medium of claim 1, wherein the executable instructions to generate include executable instructions to extract metadata from multiple data warehouses.

5. The computer-readable medium of claim 1, wherein the executable instructions to generate include executable instructions to enhance database information to include database view information.

6. The computer-readable medium of claim 1, wherein the executable instructions to generate include executable instructions to enhance database information to include aliases.

7. A computer implemented method of processing data, comprising:
extracting query information from a report;
generating database information characterizing table and column metadata for a data source; and
analyzing the relationships between the query information and the database information to identify a table and column invoked by the report.

8. The method of claim 7, wherein extracting includes extracting a Structured Query Language (SQL) statement from the report.

9. The method of claim 7, further comprising producing a table containing report dependencies on database tables and columns.

10. The method of claim 7, wherein generating includes extracting metadata from multiple data warehouses.

11. The method of claim 7, wherein generating includes enhancing database information to include database view information.

12. The method of claim 7, wherein generating includes enhancing database information to include aliases.
